(19) United States
(12) Patent Application Publication
(10) Pub. No.: US 2008/0262905 A1
(43) Pub. Date: Oct. 23, 2008

(54) Sports fan assocation business methods

(76) Inventors: Anthony Casella, Cushing, ME (US); Roger Bintliff, Edgecomb, ME (US)

Correspondence Address: Lawson & Persson P.C., P.O. Box 712, Laconia, NH, 03247, US

(21) Appl. No.: 11/787,915

(22) Filed: Apr. 18, 2007

(51) Int. Cl. G07C 13/00; G06F 17/30

(52) U.S. Cl. 705/12; 705/10

(57) ABSTRACT

Methods of conducting the business of an association of sports fans. The methods involve the use of direct member voting to control actions that are taken by the association and by third parties, and providing member specific information to members.

### FIELD OF THE INVENTION

The present invention relates to the business methods and, in particular, to methods of conducting the business of an association of sports fans.

### BACKGROUND OF THE INVENTION

Competitive sports are big business and also the largest entertainment pastime in the world from grade school to pro. Today, sporting events can be heard on radio, viewed in person or on television at almost any time of any day. The prime driver behind the explosion in the business of sports has been the willingness of sports fans to watch sports and to spend their money on the sports that they love.

Exponential growth in spectator sports in recent years can be credited to the unlimited access and participation allowed the spectator through multi-media. Sports fans tend to be passionate about the sports that they follow, and sports talk radio has also become an extremely popular forum for sports fans to express their opinions about issues relating to their sports. Similarly, many web sites have proliferated that are dedicated to providing sports fans with sources of information and further outlets for them to express their opinions. Unfortunately, despite the many outlets for fans to obtain information and express their views, this information is not compiled in any user-specific manner and fans' views are now fragmented and are not brought together in any meaningful way. Further, these views are now expressed after the sporting event concludes, and no mechanism now exists for sports fans to express their views in a manner that allows them to effect change in the outcome of a live sporting event, or even have their opinion heard in real time; let alone as a registered group creating opinions from the masses that really object to a bad decision. We believe that is a disservice to the fans and the sports industry insofar as there is a vast group unheard from whose voice, when heard, could effect the direction of a given sports industry

Associations, such as trade associations, typically represent the interests of their members and conduct activities such as lobbying, standards setting, and education to its members. Associations exist in a large number of industries and endeavors. For example, the American Association of Retired People (AARP) represents the interests of members over the age of 55, while the American Bar Association represents the interests of its attorney members. In the field of sports, associations such as the Major League Baseball Players Association, the NFL Players Association, and others, represent the interests of professional sports players. Similarly, associations exist on the amateur level in groups such as the AAU, United States track and field Association, the United States golf Association, and others are involved in sports specific activities of interest to their members. Each of these associations caters specifically to participants in the sporting activities and not to those people who are fans of these sports. Further, no single association involves itself in a wide variety of sports.

Some current sports associations include charitable foundations aimed at promoting their particular sports. These foundations are typically run by staff and boards of directors, who review funding requests and award grants based upon the result of their review. Such foundations may also have relationships with providers of new and/or used sporting goods, who can provide free or discounted sporting goods to worthy groups. However, there currently is no way for members of an association to directly determine who receives grants. Further, there is no way for groups needing donations of new and/or used sporting goods to interact directly with other groups, and providers, who may be able to help them.

Finally, despite the great many sources of information on professional and college level sports, there is currently no central source of information relating to youth sports leagues. Thus, friends and family members who live a great distance away, or service men and women stationed overseas, have no way to keep track of their own “Future All Stars”, other than through direct contact with the participants.

Therefore, there is a need for an association of sports fans that caters to fans of a broad range of sports, that brings together the views of the fans of the sports in a single location that can be used by officials, players, and the management of sports teams, allows fans to have a voice in deciding issues relating to their sport both after the games are played and during the games themselves, that provides grants to youth and high school athletic programs in which members directly determine who receives grants, that provides a means for groups needing donations of new and/or used sporting goods to interact directly with other groups, and providers, who may be able to help them, and that provides a central source of information relating to youth sports leagues.

### SUMMARY OF THE INVENTION

The present invention is directed to methods of conducting the business of an association of sports fans. One group of embodiments of the method involves the use of direct member voting to control actions that are taken by the association and by third parties. In their most basic form, these methods include the steps of registering a plurality of sports fans to serve as members and providing the members with access to a members website. The step of providing members with access to a members website includes the steps of creating a voting web page comprising at least one question for members to vote upon and transmitting the voting web page to members. Once the members transmit their votes, the method includes receiving votes cast by the members, generating results based upon the receiving step, transmitting a web page that includes the results, and taking a predetermined action based upon the results.

In preferred embodiments of the methods that include member voting, the registering step includes the steps of requesting that members identify at least one of a sport and a sport league that is of interest to the members, requesting that members provide demographic information, and storing results of each of the requesting steps in a member database. It is preferred that the demographic information include age, median family income, address, educational background, participation background for sports identified to be of interest, and/or team loyalty information. In some such embodiments, the information received by the members is used to impact the results of the vote. In these embodiments, the method also includes the step of linking votes received from members in the receiving step to demographic information of the members and weighting the votes cast by the members based upon the information provided by the members in the receiving step.

In preferred embodiments of the methods that include member voting, the association performs the steps of negotiating with a third party to agree to take a predetermined action based upon the results of the member vote. In these embodiments, the step of taking a predetermined action based upon the results includes instructing the third party to take the predetermined action. In some embodiments, the negotiating step includes negotiating with the third party to agree to allow the result to effect a decision made in a live sporting event, which may including decisions relating to replay decisions and/or penalty decisions. In other embodiments, the negotiating step includes negotiating with the third party to agree to allow the result to effect a disciplinary decision, a personnel decision, and/or a rulemaking decision.

Some embodiments of the methods that include member voting include the step of sending a wireless text message to members including at least one question for members to vote upon; and receiving text message votes cast by said members.

In some embodiments of the methods that include member voting, the registering step includes the step of requesting that the members designate a fund in which a donation is to be credited and the method includes the further step of crediting an amount of the donation to the fund. In some such embodiments, the step of requesting that a member designate fund includes requesting that a member designate a fund corresponding to at least one specific criterion, including a sport, a level of competition, a geographic area, and/or an athletic program. In some such embodiments, the step of posting questions for members to vote upon includes posting questions relating to the acceptance of grant proposals and the step of taking a predetermined action based upon the results includes donating at least of portion of the amount credited to the fund based upon the results.

Another group of embodiments of the method do not require member voting, but rather relate to the provision of member specific information to members based upon the information that the members provide. In their most basic form, these methods include the steps of registering a plurality of sports fans as members. The registering step includes requesting that members identify all sports that are of interest to the members, requesting that members identify all sports leagues that are of interest to the members, requesting that members provide demographic information, receiving results of the requesting steps transmitted by the members, and storing results of each of the requesting steps in a member database. The method also includes the step of providing the members with access to a website, which includes the sub-steps of accessing results of each of the requesting steps stored in the database, compiling member specific information based upon the results, creating a member specific web page comprising the compiled member specific information, and transmitting the member specific website for viewing by the member.

In some such embodiments, the method includes the steps of receiving youth sports league information from the members, creating at least one youth sports league web page containing the youth sports league information, and creating a member specific web page that includes at least one link to at least one youth sports league web page. In such embodiments, it is preferred that the method include the steps of receiving access information from the members and limiting transmission of at least one youth sports web page based upon the access information received from the members.

In some embodiments of the method, the registering step also includes the step of requesting that the members designate a fund in which a donation is to be credited and the method includes the further steps of crediting an amount of the donation to the fund based upon the result of the receiving step, creating a fund web page that includes a description of the fund and a total amount credited to the fund, and creating a member specific web page that includes at least one link to the fund web page.

Some embodiments of the method include the step of receiving grant requests, creating a grant request web page that includes the grant requests, and creating a member specific web page that includes at least one link to the grant request web page.

In some embodiments of the method the website is not member specific, but rather includes information relating to at least two different professional, collegiate, and high school sports, and includes member provided information relating to youth sports. In such embodiments, the method includes the steps of registering a plurality of members, wherein said members are sports fans and providing the members with access to a website. The providing step includes the steps of compiling information relating to at least two different professional, collegiate, and high school sports; creating web pages that include the compiled information, receiving youth sports league information from the members; creating at least one youth sports league web page containing the youth sports league information; and creating a member web page containing links to said youth sports league web page and web pages that include the compiled information relating to at least two different professional, collegiate, and high school sports, and transmitting the member web page for viewing by said member.

In some such embodiments, the members providing youth sports information may restrict access to the information. In these embodiments, the method includes the steps of receiving access information from the members and limiting transmission of at least one youth sports web page based upon the access information received from the members.

In other embodiments, the website includes grant request pages and/or donation offer pages. In these embodiments, the method includes the steps of receiving grant requests and/or donation offers, creating a grant request and/or donation offer web page, and creating a member web page with links to these pages.

Therefore, it is an aspect of the invention to provide a method of conducting the business of an association of sports fans in which the association serves fans of a broad range of sports.

It is a further aspect of the invention to provide a method of conducting the business of an association of sports fans that brings together the views of the fans of the sports in a single location that can be used by officials, players, and the management of sports teams.

It is a further aspect of the invention to provide a method of conducting the business of an association of sports fans that allows fans to have a voice in deciding issues relating to their sport.

It is a further aspect of the invention to provide a method of conducting the business of an association of sports fans that utilizes a website that provides targeted information based upon the member's particular demographic information.

It is a further aspect of the invention to provide a method of conducting the business of an association of sports fans that allows members to watch the live sporting event and cast votes that will affect the outcome thereof.

It is a further aspect of the invention to provide a method of conducting the business of an association of sports fans that allows its members to decide the outcome of replay challenges.

It is a further aspect of the invention to provide a method of conducting the business of an association of sports fans that allows its members to affect penalties assessed by game officials.

It is a further aspect of the invention to provide a method of conducting the business of an association of sports fans that allows its members to affect or determine the imposition of sanctions on players and teams.

It is a further aspect of the invention to provide a method of conducting the business of an association of sports fans that allows its members to affect or determine changes to existing rules.

It is a further aspect of the invention to provide a method of conducting the business of an association of sports fans that allows its members to affect or determine free agent signings and contract negotiations by individual teams.

It is a further aspect of the invention to provide a method of conducting the business of an association of sports fans in which certain demographical information is used to affect results of the member voting.

It is a further aspect of the invention to provide a method of conducting the business of an association of sports fans in which voting may take place on the Association's Internet website, or may be performed using land-based or mobile phones, or by using kiosks located at the venues themselves.

It is a further aspect of the invention to provide a method of conducting the business of an association of sports fans in which members may communicate with players, officials and commentators of note in connection with issues that are being voted upon in order to become fully informed about the issues.

It is a further aspect of the invention to provide a method of conducting the business of an association of sports fans in which the association will serve as a conduit for fans to file grievances or disputes with sports leagues and teams.

It is a further aspect of the invention to provide a method of conducting the business of an association of sports fans in which the association will serve as a mediator or arbitrator for disputes between members and sports teams or leagues.

It is a further aspect of the invention to provide a method of conducting the business of an association of sports fans in which the association provides grants to youth and high school athletic programs in which members directly determine who receives grants.

It is a further aspect of the invention to provide a method of conducting the business of an association of sports fans in which the association that provides a means for groups needing donations of new and/or used sporting goods to interact directly with other groups, and providers, who may be able to help them.

It is a still further aspect of the invention to provide a method of conducting the business of an association of sports fans in which the association provides a central source of information relating to youth sports leagues.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a flow chart showing the modules of the preferred website used in connection with the present invention.

### DETAILED DESCRIPTION OF THE INVENTION

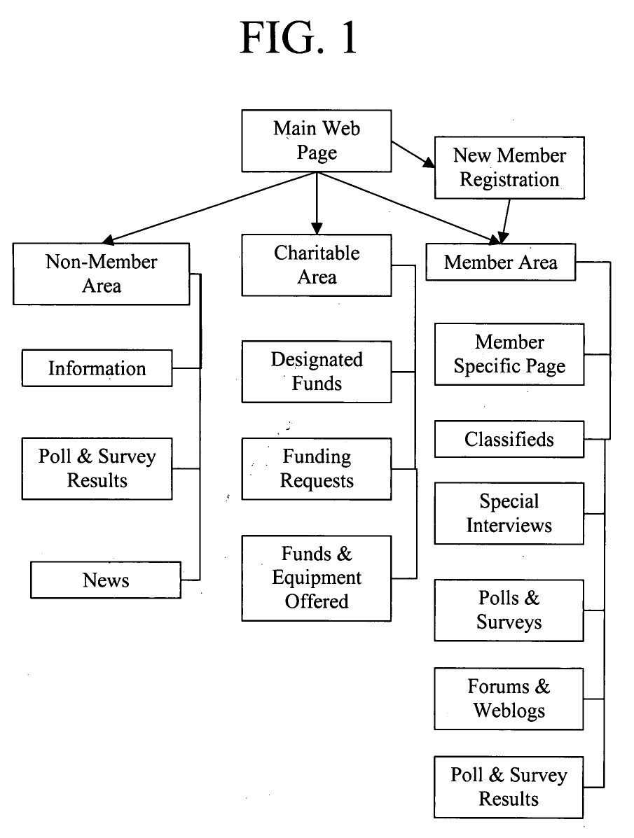

The present invention is directed to methods of conducting the business of an association of sports fans. It is preferred that the methods of the present invention be executed by an Internet web site, although the methods may also be performed by other means, such as through wireless phones, Intranets, or other art recognized means. A flowchart showing modules of the preferred website for executing the methods is shown in FIG. 1. The coding of such a website is well within the capability of those of ordinary skill in the art of website development and, the specific code required to operate the website is not disclosed herein.

In one embodiment of the method, the association recruits fans of a number of different sports, who register as members and pay a membership fee to the Association. As part of the registration process, the new member will identify all of the sports that the fan follows in all of the sports leagues in which the fan has an interest. In addition, the fan will provide demographic information such as age, median family income, address, educational background, participation background for the sports identified to be of interest; i.e. years and/or levels played, officiated, coached, etc., and team loyalty information. This information will be used later by the Association to customize the information provided to the fan and provide targeted data to interested parties. Finally, the new member will be presented with a set of membership rules and guidelines that must be followed.

When the registration process is complete, the new member will be assigned a username and password that will allow the member to access a web site for association members. The operation of the web site is an important component of the method of conducting business of the present invention and is described in detail herein.

The Association web site preferably includes links to a number of pages relating to different sports, with separate pages relating specifically to leagues and teams, as well as pages that are generated based upon the interests of the individual fan accessing the site. In one embodiment, the web site will automatically configure itself based on the demographic information provided by the member and will provide immediate access to the information that is most relevant to him or her. This information may include scores, statistics, commentary relating to recent events, requests for input on questions pertinent to the fan's interests, results of recent polls on questions pertinent to the fan's interest, special offers targeted to fans having similar interests, links to live audio and video feeds, links to third party articles that may be of interest to the fan, weblog and discussion group postings, etc.

One unique feature of the website is the ability of members to vote on issues relating to sports of interest and to have their votes affect the result of the issue on which they are voting. In one embodiment of the method, the Association will negotiate with sports leagues to allow their members to have a direct voice in the outcome of decisions made in a live sporting event, and members will be able to watch the live sporting event and cast votes that will affect the outcome of certain decisions.

For example, the Association may negotiate with a football league, such as the Arena Football League, NFL Europe, or the like, to allow its fans decide the outcome of decisions made on replay challenges. In such a scenario, the Association's members would be shown the video replay and provided with an explanation of the rule under which the replay would be decided. Members of the Association would then view the replay and cast their votes on whether or not the ruling on the field should be upheld or overturned and the decision of the members would control the outcome of the challenge.

Another example of where member voting will affect the outcome of a decision made in a live sporting event is in the area of penalties assessed by game officials. For example, a baseball, hockey or basketball official may unfairly eject a player or manager from game, or may not see something that would cause him or her to eject that player. Similarly, a hockey player may be given a major penalty when a minor penalty should have been assessed, or vice versa. In these situations, the Association would negotiate with the league to allow member voting on these situations, the members would vote to change the outcome, and the results of the voting would be used by the officials to change the outcome of the event.

In some embodiments of the method, the Association will negotiate with sports leagues and players associations to allow fan voting to affect or determine the outcome of disciplinary decisions, such as the imposition of sanctions on players and teams. Traditionally, such sanctions have been unilaterally issued by the league office responsible for such sanctions or directly by the commissioner of the league. However, in such embodiments of the business method of the present invention, members would be allowed to vote on the appropriate sanction for the behavior of a player, coach, team executive and/or owner and the result of such voting would determine what sanctions are imposed.

For example, the National Football League reviews plays submitted to the league office each week during the season and issues fines and suspensions for certain players' behavior, such as late hits, unnecessary roughness penalties, etc. Under the method of the present invention, the Association's members would be allowed to vote on these sanctions and the results of this voting would determine whether the player is to be fined, what amount he should be fined and whether a suspension is warranted. Similarly, the fans may vote to uphold or deny sanctions imposed by the league offices; i.e. if a player receives a fine or suspension from the league, the Association's members would be allowed to vote on whether the sanction imposed was appropriate and, if the vote results in a finding that it was inappropriate, the league would need to reevaluate the sanction and issue a new sanction.

In other embodiments of the method, the Association will negotiate with sports leagues to allow fan voting to determine the result of rulemaking decisions, such as the addition of new rules and changes to existing rules. For example, the National Football League has a “competition committee”, made up of representatives of a number of teams, that proposes new rules and changes to existing rules, considers the proposals, and either approves or denies the necessary changes. In some embodiments of the method of the present invention, members of the Association would vote to approve or disapprove the adoption of new rules or changes to existing rules. This vote may be binding upon the league, or may be used to augment the function of a league committee. For example, the Association could negotiate a bicameral voting approach in which both an affirmative fan vote and a league vote would be required in order for a change to be implemented. Conversely, the Association could negotiate a system similar to that currently used by the National Football League in connection with Pro Bowl voting, in which the results of fan voting are given a certain percentage of the vote along with the votes of the coaches and players. Still other voting methods may also be negotiated and these are but examples of what procedures may be utilized.

In other embodiments of the method, the Association will negotiate with individual teams to allow fan voting to affect or determine player personnel decisions, such as free agent signings and contract negotiations. As discussed above, the Association may negotiate to allow member votes to affect such matters in a number of different ways. The member vote could be binding on the team, could augment the team's decision-making process by granting veto power or a percentage of the vote on an issue, or may merely serve as advice that the team would agree to consider when making its final decision.

In embodiments of the method that include member voting, certain demographical information may be used to affect results of the member voting. For example, in the case of votes affecting live sporting events, votes cast by members who live in the geographic area of one of the teams participating, or have identified one of the teams as being teams to which they are loyal, may be excluded from voting. Similarly, votes cast by members having experience as coaches, participants, or officials of the sports in question may be given greater weight that those of members who have no such experience. Other criteria, such as age, educational background, or other criteria agreed upon by the sports league or team and the Association may likewise be used in connection with the voting.

Member voting may take place on the Association's Internet website, or may be performed using land-based or mobile phones, or by using kiosks located at the venues themselves. In either scenario, the member will be identified by the Association by entering a unique personal identifier, and then will be allowed to vote. Similarly, where voting is taking place relative to a live event, the Association may sent wireless text messages to members seeking their immediate input and will accept and tally text message responses in the results. Regardless of how the information is sent by the member, it will be received by the Association's servers and processed in the same manner as Internet votes.

In some embodiments that include member voting, the Association will negotiate to obtain the ability of members to communicate with players, officials and commentators of note in connection with issues that are being voted upon in order to become fully informed about the issues. This communication may be in substantially real time in the form of a live web cast, or may take the form of a discussion group in which the players, officials and/or commentators review questions posed by members and respond at a later time. These responses may be text responses, may be recorded and played as video files from the website, or may be in the form of a streaming web cast at a predetermined time.

In some embodiments of the method, the members may submit questions that they would like included in polls to be voted on by the members. In some embodiments, these questions will automatically be posted while, in others, the Association will review all posted questions and choose specific questions for member votes. In still other embodiments, sports leagues, teams, players and/or officials will pose questions for member voting.

In embodiments where polling takes place, it is preferred that database demographics and poll results be disseminated to electronic, television and print media outlets. In addition, result communiqués will be dispatched to the league, player association or governing board relevant to the matter at hand.

In some embodiments of the method, the Association will serve as a conduit for fans to file grievances or disputes with sports leagues and teams. In others, the Association will serve as a mediator or arbitrator for such disputes. In other embodiments, members will have the opportunity to communicate their concerns and insight relating to a given college or professional league via weblogs and/or discussion groups. For example, the Association may set up weblogs or discussion groups relating to the NFL Draft, the Heismann Trophy award, Major League Baseball All Star selections, Bowl Championship Series match ups, NCAA basketball tournament selections, or the like.

In addition to focusing on major professional and college sports, the Association will also serve as a conduit for funding to youth and high school athletic programs. Still another unique feature of the invention is the manner in which the Association will provide such funding. The method of funding youth and high school athletic programs has two basic components; the fundraising component and the distribution component.

Looking first to the fundraising component, the Association will donate a certain percentage of each member's membership fee to a charitable foundation set up for the purpose of funding amateur athletics. During the membership registration process, the new member may choose to have this donation put into a general pool for distribution, or may designate this donation to a specific sport, a specific level of competition, such as youth, high school, national and international amateur competition, etc., a specific geographic area, and/or a specific athletic program. Similarly, monies received from the Association's sponsors, or third party donors may be likewise earmarked. Depending upon the criteria set by the donor, funds will be allocated in accordance with their wishes and added to separate “available grant” pages that will be shown on the Association's website and may be accessed by amateur athletic programs and participants wishing to receive funds.

Looking to the selection component, amateur athletic programs and participants wishing to receive funds will be allowed to periodically submit grant proposals to the Association. These proposals will preferably be prepared and submitted electronically through the website such that they may be easily posted for review by the members. In some embodiments, all members will be allowed to vote to determine which grant proposals will be accepted and which will be denied. In others, only those members whose donations were earmarked toward a specific grant criterion will be allowed to vote. In such embodiments, if a member earmarked its donation to the general fund, it would be allowed to vote on grant proposals submitted for funding by the general fund, but would not be allowed to vote on proposals submitted for restricted funds, and vice versa. For example, if a proposal were submitted for a fund allocating donations for lacrosse in the State of Florida, only those members who earmarked their donations for lacrosse in the State of Florida would be allowed to vote. In other embodiments, members earmarking donations for one applicable criterion would be allowed to vote on any proposal relevant to that criterion. Thus, if a proposal were submitted for a fund allocating money for lacrosse in the State of Florida, only those members who earmarked their donations for lacrosse or earmarked their donations for programs in the State of Florida would be allowed to vote. The results of the voting would be posted and the funding would be distributed in accordance with results of the vote.

Another key feature of the invention is the provision of a means for amateur athletic programs and participants wishing to receive funds and/or donations of new and/or used sporting goods to interact directly with companies, individuals and other groups in order to get their needs met. In some embodiments, programs and participants may post proposals for grants, or other needs, on the Association's website during periods between grant cycles so that members, other organizations and/or businesses can learn about their needs and provide assistance. In others, programs and participants who have posted proposals for grants that members have not voted to fund will be posted in a special portion of the Association's website, where companies and/or individual donors may choose to step up and provide the requested equipment and/or funds.

In still other embodiments, the Association will include a page on its website where companies, individuals and groups can post donation offers to allow amateur groups to obtain funding and/or equipment for their programs. In some such embodiments, groups having used equipment that they would like to donate rather than discard can post this on the website so that other groups may claim the equipment. In others, companies and groups with money available can post funding and/or equipment opportunities for other groups. For example, a company such as Nike could post an opportunity for a group to obtain discounted athletic equipment provided the group met certain criteria and/or agreed to display the Nike logo on its equipment or at its facility. Similarly, a company like General Mills could post an opportunity for a group to obtain funding if it provided a certain number of cereal box tops, etc. As is readily apparent, the means by which the Association assists amateur groups is varied and may take many forms.

Still another unique feature of the present invention is the provision of access to information on youth and community-based sports, and the manner in which this access is provided. In some embodiments of the present invention, groups wishing to receive funding will be required to post information about their leagues, which may include statistics, updates and highlights for access within a members only section of the Association's website. In other embodiments, members will be allowed to create their own information pages on local sports teams and leagues of interest. These pages may include photographs, links to local newspaper articles, video clips or the like, so as to allow relatives and friends to be a part of their own “Future All Star's” budding career. Further, in order to avoid the threat of on-line predators improperly using the community pages, in some embodiments, people seeking to access these pages must first obtain approval from the posting member, or the league, in order to obtain access. This may be in the form of a password that could be provided to friends and relatives, or an email request by the party seeking to access the pages.

In some embodiments of the method, the Association will negotiate to obtain access to event tickets, which will be available exclusively to members of the Association. In others, the Association will negotiate to obtain access to exclusive merchandise, which will be available exclusively to members of the Association.

Finally, in still other embodiments of the invention, the website will include a members-only section that allows members to trade, buy and sell sports memorabilia, souvenirs and collectors items.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A method of conducting the business of an association of sports fans comprising the steps of:
registering a plurality of members, wherein said members are sports fans;
providing said members with access to a member website, wherein said step of providing members with access to a member website comprises the steps of creating a voting web page comprising at least one question for members to vote upon and sending said voting web page to members;
receiving votes cast by said members;
generating results based upon said receiving step;
sending a web page comprising said results; and
taking a predetermined action based upon said results.

2. The method as claimed in claim 1 wherein said registering step comprises the steps of:
requesting that members identify at least one of a sport and a sport league that is of interest to said members;
requesting that members provide demographic information;
receiving responses to said requesting steps from said members; and
storing responses received by said members in a member database.

3. The method as claimed in claim 2 wherein said demographic information comprises at least one of a group consisting of age, median family income, address, educational background, participation background for sports identified to be of interest, and team loyalty information.

4. The method as claimed in claim 3 further comprising the step of linking votes received from members in the receiving step to demographic information of said members, wherein said step of generating results comprises the step of weighting said votes cast by said members based upon said demographic information of said members.

5. The method as claimed in claim 4 further comprising the step of negotiating with a third party to agree to take a predetermined action based upon said results, and wherein said step of taking a predetermined action based upon said results comprises instructing said third party to take said predetermined action.

6. The method as claimed in claim 5 wherein said step of negotiating with a third party to agree to take a predetermined action based upon said results comprise negotiating with said third party to agree to allow said result to effect a decision made in a live sporting event.

7. The method as claimed in claim 6 wherein said step of negotiating with said third party to agree to allow said result to effect a decision made in a live sporting event comprises negotiating with said third party to agree to allow said result to effect a decision selected from a group consisting of a replay decision and a penalty decision.

8. The method as claimed in claim 5 wherein said step of negotiating with a third party to agree to take a predetermined action based upon said results comprise negotiating with said third party to agree to allow said result to affect a decision selected from a group consisting of a disciplinary decision, a personnel decision, and a rulemaking decision.

9. The method as claimed in claim 1 further comprising the step of negotiating with a third party to agree to take a predetermined action based upon said results, and wherein said step of taking a predetermined action based upon said results comprises informing said third party of said results and instructing said third party to take said predetermined action.

10. The method as claimed in claim 9 wherein said step of negotiating with a third party to agree to take a predetermined action based upon said results comprise negotiating with said third party to agree to allow said result to effect a decision made in a live sporting event.

11. The method as claimed in claim 10 wherein said step of negotiating with said third party to agree to allow said result to effect a decision made in a live sporting event comprises negotiating with said third party to agree to allow said result to effect a decision selected from a group consisting of a replay decision and a penalty decision.

12. The method as claimed in claim 9 further comprising the step of sending a wireless text message to members comprising at least one question for members to vote upon; and receiving text message votes cast by said members.

13. The method as claimed in claim 9 wherein said step of negotiating with a third party to agree to take a predetermined action based upon said results comprises negotiating with said third party to agree to allow said result to affect a decision selected from a group consisting of a disciplinary decision, a personnel decision, and a rulemaking decision.

14. The method as claimed in claim 9 wherein said step of negotiating with a third party to agree to take a predetermined action based upon said results comprises negotiating with a team to agree to allow said results of member votes to impact player personnel decisions.

15. The method as claimed in claim 14 wherein said step of negotiating with a team to agree to allow members to impact player personnel decisions comprises negotiating with a team to agree to allow said results of said member votes to prevent said team from taking an action.

16. The method as claimed in claim 2:
wherein said registering step further comprises the steps of requesting that said members designate a fund in which a donation is to be credited; and
wherein said method further comprises the steps of receiving designations of donations to funds from members; and
crediting amounts of said donations to said funds.

17. The method as claimed in claim 16 wherein said step of requesting that a member designate a fund comprises requesting that a member designate a fund corresponding to at least one specific criterion and wherein said at least one specific criterion comprises a sport, a level of competition, a geographic area, and an athletic program.

18. The method as claimed in claim 17 wherein said step of creating a voting web page comprises creating a voting web page comprising questions relating to the acceptance of grant proposals; and wherein said step of taking a predetermined action based upon said results comprises donating at least of portion of said amount credited to said fund based upon said results.

19. The method as claimed in claim 18 wherein said method further comprises the step of linking votes received from members to funds designated by said members; and wherein said step of generating results comprises the step of weighting said votes cast by said members based upon said funds designated by said members.

20. A method of conducting the business of an association of sports fans comprising the steps of:
registering a plurality of members, wherein said members are sports fans and wherein said registering step comprises the steps of:
requesting that members identify all sports that are of interest to said members;
requesting that members identify all sports leagues that are of interest to said members;
requesting that members provide demographic information; receiving results of the requesting steps transmitted by said members; and
storing results of each of said requesting steps in a member database; and
providing said members with access to a website, wherein said providing step comprises the steps of:
accessing results of each of said requesting steps stored in said database;
compiling member specific information based upon said results;
creating a member specific web page comprising said compiled member specific information; and
transmitting said member specific website for viewing by said member.

21. The method as claimed in claim 20 further comprising the steps of receiving youth sports league information from said members and creating at least one youth sports league web page containing said youth sports league information, wherein said step of in creating a member specific web page comprises creating a member specific web page comprising at least one link to said at least one youth sports league web page.

22. The method as claimed in claim 21 further comprising the steps of receiving access information from said members and limiting transmission of said at least one youth sports web page based upon said access information received from said members.

23. The method as claimed in claim 20 wherein said registering step further comprises the step of requesting that said members designate a fund in which a donation is to be credited;
wherein said method further comprises the steps crediting an amount of said donation to said fund based upon a result of said receiving step and creating a fund web page comprising a description of said fund and a total amount credited to said fund; and
wherein said step of creating a member specific web page comprises creating a member specific web page comprising at least one link to said fund web page.

24. The method as claimed in claim 20 further comprising the steps of receiving grant requests and creating a grant request web page comprising said grant requests; and
wherein said step of creating a member specific web page comprises creating a member specific web page comprising at least one link to said grant request web page.

25. The method as claimed in claim 23 further comprising the steps of receiving grant requests for each fund and creating a grant request web page comprising said grant requests for each fund; and
wherein said step of creating a member specific web page comprises creating a member specific web page comprising at least one link to said grant request web page for each fund designated by said member.

26. The method as claimed in claim 20 further comprising the steps of receiving donation offers and creating a donation offer web page comprising said donation offers; and
wherein said step of creating a member specific web page comprises creating a member specific web page comprising at least one link to said donation offer web page.

27. A method of conducting the business of an association of sports fans comprising the steps of:
registering a plurality of members, wherein said members are sports fans; and
providing said members with access to a website, wherein said providing step comprises the steps of:
compiling information relating to at least two different professional, collegiate, and high school sports;
creating web pages comprising said compiled information;
receiving youth sports league information from said members;
creating at least one youth sports league web page containing said youth sports league information; and
creating a member web page comprising links to said youth sports league web page and web pages comprising said compiled information; and
transmitting said member web page for viewing by said member.

28. The method as claimed in claim 27 further comprising the steps of receiving access information from said members and limiting transmission of said at least one youth sports web page based upon said access information received from said members.

29. The method as claimed in claim 27 further comprising the steps of receiving grant requests and creating a grant request web page comprising said grant requests; and
wherein said step of creating a member web page comprises creating a member specific web page comprising at least one link to said grant request web page.

30. The method as claimed in claim 27 further comprising the steps of receiving donation offers and creating a donation offer web page comprising said donation offers; and
wherein said step of creating a member web page comprises creating a member specific web page comprising at least one link to said donation offer web page.
